(19) United States
(12) Patent Application Publication
(10) Pub. No.: US 2023/0401851 A1
(43) Pub. Date: Dec. 14, 2023

(54) TEMPORAL EVENT DETECTION WITH EVIDENTIAL NEURAL NETWORKS

(71) Applicant: NEC Laboratories America, Inc., Princeton, NJ (US)

(72) Inventors: Xuchao Zhang, Elkridge, MD (US); Xujiang Zhao, Plano, TX (US); Yuncong Chen, Plainsboro, NJ (US); Wenchao Yu, Plainsboro, NJ (US); Haifeng Chen, West Windsor, NJ (US); Wei Cheng, Princeton Junction, NJ (US)

(21) Appl. No.: 18/332,057

(22) Filed: Jun. 9, 2023

Related U.S. Application Data
(60) Provisional application No. 63/350,913, filed on Jun. 10, 2022.
(60) Provisional application No. 63/419,092, filed on Oct. 25, 2022.

(51) Int. Cl. G06V 20/40; G06V 20/52; G06V 10/82

(52) U.S. Cl. CPC G06V 20/44; G06V 20/52; G06V 10/82; G06T 2207/20081

(57) ABSTRACT

Methods and systems for event detection include training a joint neural network model with respective neural networks for audio data and video data relating to a same scene. The joint neural network model is configured to output a belief value, a disbelief value, and an uncertainty value. It is determined that an event has occurred based on the belief value, the disbelief value, and the uncertainty value.

### RELATED APPLICATION INFORMATION

This application claims priority to U.S. Patent Appl. No. 63/350,913, filed on Jun. 10, 2022, and to U.S. Patent Appl. No. 63/419,092, filed on Oct. 25, 2022, incorporated herein by reference in their entirety.

### BACKGROUND

### Technical Field

The present invention relates to event detection and, more particularly, to early event detection using multiple data sources.

### Description of the Related Art

Event detection uses measurements from a set of sensors in a system to identify significant conditions in the system's operation. Such events may include recognition of changes to the state of the system as well as hazards that may affect the functioning of the system or the safety of those nearby.

### SUMMARY

A method for event detection includes training a joint neural network model with respective neural networks for audio data and video data relating to a same scene. The joint neural network model is configured to output a belief value, a disbelief value, and an uncertainty value. It is determined that an event has occurred based on the belief value, the disbelief value, and the uncertainty value.

A system for event detection includes a hardware processor and a memory that stores a computer program. When executed by the hardware processor, the computer program causes the hardware processor to train a joint neural network model with respective neural networks for audio data and video data relating to a same scene. The joint neural network model is configured to output a belief value, a disbelief value, and an uncertainty value. It is determined that an event has occurred based on the belief value, the disbelief value, and the uncertainty value.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of a cyber-physical system with a maintenance system that performs event detection, in accordance with an embodiment of the present invention;

FIG. 2 is a block/flow diagram of a method for detecting and correcting events within a cyber-physical system, in accordance with an embodiment of the present invention;

FIG. 3 is a diagram of a neural network model for processing audio and video data, in accordance with an embodiment of the present invention;

FIG. 4 is a diagram of a neural network architecture that can be used to implement a neural network model, in accordance with an embodiment of the present invention;

FIG. 5 is a diagram of a deep neural network architecture that can be used to implement a neural network model, in accordance with an embodiment of the present invention; and

FIG. 6 is a block diagram of a computer processing system that can perform event detection, in accordance with an embodiment of the present invention.

### DETAILED DESCRIPTION OF PREFERRED EMBODIMENTS

Early event detection aims to detect events before the event is complete, and in some cases before the event has even begun. Recognizing events in contexts with multiple labels is a particular challenge, as is overconfidence in predictions that arise from a high vacuity uncertainty early in a time series, which is uncertainty that results from a lack of evidence. Overconfident estimates produce unreliable predictions.

A multi-label temporal evidential neural network may therefore be used for multi-label uncertainty estimation in temporal data. An uncertainty estimation head uses a weighted binomial comultiplication to quantify the fused uncertainty of a sub-sequence for early event detection.

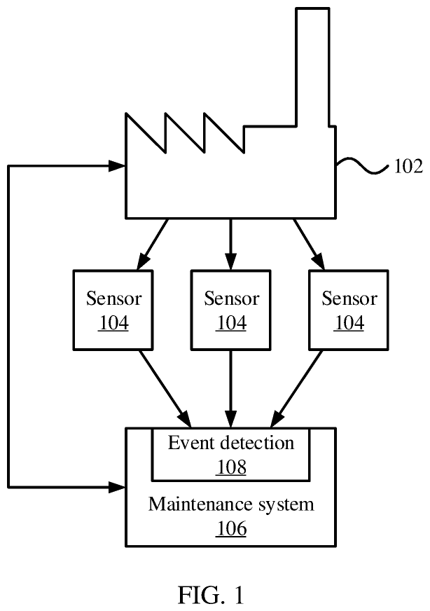

Referring now in detail to the figures in which like numerals represent the same or similar elements and initially to FIG. 1, a maintenance system 106 in the context of a monitored system 102 is shown. The monitored system 102 can be any appropriate system, including physical systems such as manufacturing lines and physical plant operations, electronic systems such as computers or other computerized devices, software systems such as operating systems and applications, and cyber-physical systems that combine physical systems with electronic systems and/or software systems. Exemplary systems 102 may include a wide range of different types, including railroad systems, power plants, vehicle sensors, data centers, satellites, and transportation systems. Another type of cyber-physical system can be a network of internet of things (IoT) devices, which may include a wide variety of different types of devices, with various respective functions and sensor types.

One or more sensors 104 record information about the state of the monitored 416 system 102. The sensors 104 can be any appropriate type of sensor including, for example, physical sensors, such as audio, temperature, humidity, vibration, pressure, voltage, current, magnetic field, electrical field, and light sensors, and software sensors, such as logging utilities installed on a computer system to record information regarding the state and behavior of the operating system and applications running on the computer system. The sensor data may include, e.g., numerical data and categorical or binary-valued data. The information generated by the sensors 104 can be in any appropriate format and can include sensor log information generated with heterogeneous formats.

For example, sensors 104 may be part of a security system that may capture audio and/or video information relating to the sound of breaking glass, people shouting, doors or windows being opened, the sound of someone walking in the house, or other unusual activity. In another example, sensors 104 may be part of a manufacturing facility, where audio and/or video events may be caused by the sound of machinery malfunctioning or alarms going off.

The sensors 104 may transmit the logged sensor information to an anomaly maintenance system 106 by any appropriate communications medium and protocol, including wireless and wired communications. The maintenance system 106 can, for example, identify abnormal or anomalous behavior by monitoring the multivariate time series that are generated by the sensors 104. Once anomalous behavior has been detected, the maintenance system 106 communicates with a system control unit to alter one or more parameters of the monitored system 102 to correct the anomalous behavior.

Exemplary corrective actions include changing a security setting for an application or hardware component, changing an operational parameter of an application or hardware component (for example, an operating speed), halting and/or restarting an application, halting and/or rebooting a hardware component, changing an environmental condition, changing a network interface's status or settings, etc. The maintenance system 106 thereby automatically corrects or mitigates the anomalous behavior. By identifying the particular sensors 104 that are associated with the anomalous classification, the amount of time needed to isolate a problem can be decreased.

Each of the sensors 104 outputs a respective time series, which encodes measurements made by the sensor over time. For example, the time series may include pairs of information, with each pair including a measurement and a timestamp, representing the time at which the measurement was made. Each time series may be divided into segments, which represent measurements made by the sensor over a particular time range. Time series segments may represent any appropriate interval, such as one second, one minute, one hour, or one day. Time series segments may represent a set number of collection time points, rather than a fixed period of time, for example covering 100 measurements.

The maintenance system 106 therefore includes a model that is trained handle event detection 108. For example, audio data from an audio sensor, such as a microphone, may be processed by event detection 108 to detect abnormal events within the system 102. Video data may be similarly processed, and the model may include different respective neural networks for the different types of data, jointly trained for event detection.

When an event occurs in the system 102, corresponding time series from the sensors 104 may be divided into three components, including a pre-event part, an ongoing event part, and a post-event part. Event detection 108 may provide early event detection during the ongoing portion of the event, shortly after the event begins and before the event ends. To prevent overconfidence, the uncertainty that results from vacuity—the lack of evidence—is considered. Given a binomial opinion towards a proposition x, an opinion may be expressed by two factors, belief b and disbelief d, and one uncertainty u. An opinion may be denoted as ω=(bᵢ, dᵢ, u, a), where bᵢ is a positive proposition (likelihood the event occurs on a time segment i), dᵢ is a negative proposition (likelihood the event does not occur on the time segment i), and a refers to a base rate representing prior knowledge. The terms b, d, and u are related as b+d+u=1, where b, d, u, a∈[0,1]. The expected belief probability p is defined by p=b+a·u.

A binomial opinion can be translated into a Beta distribution, denoted by Beta(p|α, β), where α and β represent positive and negative evidence:

$$Beta ( p \vert α , β ) = \frac{1}{B ( α , β )} {{p}^{α - 1} ( 1 - p )}^{β - 1}$$

where B(α, β)=Γ(a)F(β)/Γ(α+β) and Γ(⋅) is the gamma function. A mapping ule governs the interaction between the Beta distribution and an opinion:

$$b = \frac{α - a \cdot W}{α + β} , d = \frac{β - ( 1 - α ) \cdot W}{α + β} , u = \frac{W}{α + β}$$

where W is an amount of uncertainty evidence. In practice, the binary case may be represented as W=2. This approach can also be extended to a multi-class scenario with a multinomial opinion, translated into a Dirichlet distribution.

As used herein, the term “opinion” or “subjective opinion” is a term that comes from subjective logic, where evidence is a measure of the amount of support for a certain class. If there is ample evidence to support a given opinion or prediction, the vacuity uncertainty is low. Without such evidence, the vacuity uncertainty is relatively high. The evidence may be quantified by the multi-label evidential temporal neural network.

The term “vacuity” refers to the lack of adequate evidence to make a prediction. This type of uncertainty is due to a lack of information or evidence. High vacuity happens at early stages of an ongoing event, due to the small number of collected signals, which can result in overconfident predictions. As more evidence is collected, the vacuity uncertainty decreases and the accuracy of the prediction increases.

Given time series data with multiple labels, where each class label is viewed as an event, the data space may be characterized by X× [symbol] , where X is an input space and [symbol] ={0,1}^{K} is an output space, with K being a number of classes representing the different events that may be detected. A time series may be expressed as {(x^{t}, y^{t})}ₜ₌₁^{T}∈(X× [symbol] ) includes T time segments, where each (x^{t}, y^{t}) includes data collected within a time window t. The vector x^{t} is a feature vector and y^{t}=[y₁^{t}, . . . , y_{K}^{t}] denotes a multi-label formula, with yₖ^{t}={0,1}, ∀k∈{1, . . . , K} representing whether an event k occurs or not during the time segment t.

A segment buffer [symbol] may be initialized as empty and may be maintained by adding each segment, one at a time. At a timestamp t, the buffer [symbol] includes all segments from previous times: [symbol] ={(x^{t}, y^{t})}ᵢ₌₁^{t} and | [symbol] |=t. At each time segment, a predictive model ƒ:X→ [symbol] , parameterized by θ, takes segments in [symbol] as input and outputs an event prediction vector ŷ^{t}=[ŷ₁^{t}, . . . , ŷ_{K}^{t}]^{T}, where ŷₖ^{t}∈{0,1} represents the predicted result of the k^{th} event at time t. For some events which are predicted as occurrences, it can be concluded that they can be detected at time t.

Evidential uncertainty can be derived from binomial opinions or, equivalently, Beta distributions, to model an event distribution for each class. The multi-label evidential temporal neural network ƒ(⋅) forms binomial opinions for the class-level Beta distribution of time series segments [x¹, . . . , x^{t}]. The conditional probability P(pₖ^{t}|x¹, . . . , x^{t}; θ) of a class k at timestamp t can be obtained by:

[ƒ¹, . . . ,ƒ^{t}]←ƒ(x¹, . . . ,x^{t};θ)

(α₁^{t},β₁^{t}), . . . ,(α_{K}^{t},β_{K}^{t})←ƒ^{t}(x¹, . . . ,x^{t};θ)

pₖ^{t}˜Beta(pₖ^{t}|αₖ^{t},βₖ^{t})

yₖ^{t}˜Bernoulli(pₖ^{t})

where k∈{1, . . . , K}, t∈{1, . . . , T}, ƒ^{t} is the output of the neural network at timestamp t, and θ represents parameters of the neural network model. Using the Beta probability function, the neural network is able to determine predictive uncertainty due to vacuity for multi-label classifications at each time stamp.

The neural network may be trained using a binary cross-entropy loss, determined by computing a Bayes risk for the class predictor:

$$ℒ = {\sum }_{t = 1}^{T} {\sum }_{k = 1}^{K} \int [ BCE ( {y}_{k}^{t} , {p}_{k}^{t} ) ] Beta ( {p}_{k}^{t} ; {α}_{k}^{t} , {β}_{k}^{t} ) {dp}_{k}^{t}$$

$${\sum }_{t = 1}^{T} {\sum }_{k = 1}^{K} [ {y}_{k}^{t} ( ψ ( {α}_{k}^{t} + {β}_{k}^{t} ) - ψ ( {α}_{k}^{t} ) ) + ( 1 - {y}_{k}^{t} ) ( ψ ( {α}_{k}^{t} + {β}_{k}^{t} ) - ψ ( {β}_{k}^{t} ) ) ]$$

where BCE(yₖ^{t}, pₖ^{t})=−yₖ^{t} log(pₖ^{t})−(1−yₖ^{t}) log(1−pₖ^{t}) is the binary cross-entropy loss and ψ(⋅) is the digamma function. The log expectation of the Beta distribution derives the second equality. The probability of an event k at timestamp t can be represented by the belief and disbelief as:

$${\hat{p}}_{k}^{t} = \frac{{b}_{k}^{t}}{{b}_{k}^{t} + {d}_{k}^{t} + 2}$$

where bₖ^{t} represents the belief and dₖ^{t} represents the disbelief for a class k at a time t.

For early detection, at a time t, a subset including the m most recent collected time segments are considered to determine whether an event is successfully detected. The subset represents a sliding window in time, dynamically restructuring a small sequence of segments from t−m to t and performing validation through an early detection function at each time. Based on the sliding window, an uncertainty fusion operator quantifies the fused uncertainty of a sub-sequence for early event detection.

Using the sequential Beta distribution output, a sequential fusional opinion can be estimated via a union operator. A comultiplication operator may fuse the opinions, including belief, disbelief, and uncertainty. The equations below provide details on how to fuse these quantities based on opinions i and j, as follows:

$${b}_{i ⊕ j} = {b}_{i} + {b}_{j} - {b}_{i} {b}_{j}$$

$${d}_{i ⊕ j} = {d}_{i} {d}_{j} + \frac{{a}_{i} ( 1 - {a}_{j} ) {d}_{i} {u}_{j} + ( 1 - {a}_{i} ) {a}_{j} {u}_{i} {d}_{j}}{{a}_{i} + {a}_{j} - {a}_{i} {a}_{j}}$$

$${u}_{i ⊕ j} = {u}_{i} {u}_{j} + \frac{{a}_{j} {d}_{i} {u}_{j} + {a}_{i} {u}_{i} {d}_{j}}{{a}_{i} + {a}_{j} - {a}_{i} {a}_{j}}$$

a_{i⊕j}=aᵢ+aⱼ−aᵢaⱼ

Based on m slides and taking the order into consideration, the weighted sequential opinion can be determined as:

\hat{ω}^{t}=cₜ₋ₘω^{t-m}⊕cₜ₋ₘ₊₁ω^{t-m+1}⊕ . . . ⊕cₜω^{t}

where c is the weight for each opinion co when executing the operator, which is designed for the order information and emphasizes the importance of the current time step t. The weighted sequential opinion fuses m different opinions. The vacuity may be considered from \hat{ω}^{t} as a sequential uncertainty for a sub-sequence for early event detection, filtering the overconfidence by providing information about when the vacuity is large.

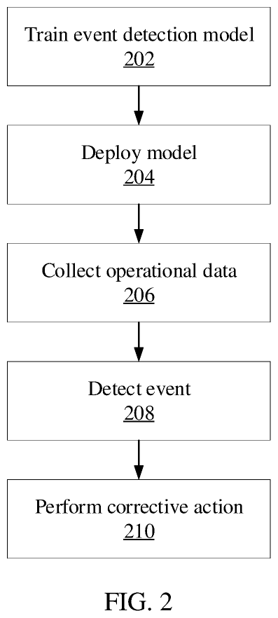

Referring now to FIG. 2, a method for event detection and response is shown. Block 202 trains an event detection model, for example by jointly training respective models that process audio and video data using a set of training data. The trained model may then be deployed 204 to a maintenance system 106 by any appropriate mechanism, for example by a wired or wireless communication medium or by physical transport of an appropriate storage medium.

The maintenance system 106 collects operational data from the sensors 104 of the system 102 in real-time at block 206. This information may be divided into different data types, such as audio and video data, with appropriate correspondences being established between data types. For example, audio and video data collected from a same location may have time stamp correspondences and may be tagged according to the location where they were collected. The audio and video data may be collected in frames, with a frame size being set sufficiently small to provide event detection at an early stage. For example, the frame size may be set to capture a window of 64 ms.

The frames may be zero-padded if needed, to fit the input layer of a neural network. This padding may be performed during both training 202 and during collection of online data 206. For online data collection 206, the frame may be padded by additional zeroes, as a longer window size compared to the hop size. The hop size refers to the number of samples between consecutive frames when processing an audio or signal stream, characterizing the overlap between adjacent frames. Window size may refer to the length of each frame or segment of the stream that is analyzed.

Using this collected data as input to the deployed model, event detection 108 identifies a relevant event at block 208. The maintenance system 106 then performs a corrective action responding to the detected event, for example performing an appropriate act to resolve an anomaly or ameliorate a hazard.

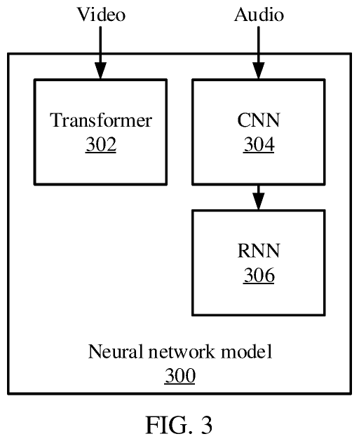

Referring now to FIG. 3, detail on the neural network model 300 is shown. Raw data streams may be parsed into their corresponding features. This may be performed for the training data during training 202 as well as for the operational data collected in block 206. For audio data, a mel-spectrogram may be used to parse the original audio waveform data into spectrogram features. A mel spectrogram is a representation of the spectrum of frequencies of a sound signal and may be obtained by applying a filter bank to the signal and then taking the logarithm of the power spectrum of each filter output. The resulting mel spectrogram may be represented as a two-dimensional matrix, where the x-axis represents time and the y-axis represents frequency. The waveform data may specifically be parsed to spectrogram features by performing a Fourier transform and then mapping the powers of the spectrogram into a mel scale. A log of powers operation may then be taken at each of the mel frequencies.

Video data may also be processed, for example cutting the video's stream of images into segments of 0.2 seconds each, so that there are five segments per second. The audio data features may be encoded by a neural network model, for example a one-dimensional convolutional neural network (CNN) 304 and a recurrent neural network (RNN) 306 with gated recurrent units (GRUs). The video data may be encoded using a transformer neural network 302.

The convolutional and recurrent neural network structure is a combination of a CNN and RNN, so that the model learns hierarchical representations and captures both local and global context. The transformer architecture includes encoder and decoder stacks. Each stack has multiple layers that perform self-attention and feed-forward operations. The self-attention allows the model to capture dependencies between different parts of the input sequence. Positional encoding accounts for the order of tokens. Residual connections and layer normalization provide gradient flow and stability. The transformer model's output may be generated by the decoder stack, incorporating information from the encoder stack.

Based on the data features collected from the audio and video data of a training dataset, ground truth onset and offset labels may be applied to train the data encoder and event detection model. These labels may be included in the training dataset, and may be output by the neural network model for newly collected data. The onset and offset labels indicate points in time when a particular event begins and ends. Weakly labeled date, with an indication of the presence of an event, may also be used. The audio and video neural networks may be jointly trained with a join loss function:

[symbol]

= [symbol] ₐ+λ [symbol] _{ν}

where [symbol] ₐ is an audio-specific loss, [symbol] _{ν} is a video-specific loss, and λ is a weighting parameter that defines a balance between the two losses. Each loss may use a respective binary cross-entropy loss, as defined above.

At the test stage, predictions may be generated based on the sequential uncertainty estimated from weighted binomial comultiplication. When, for both audio and video, the belief is greater than the disbelief and when the uncertainty is less than a threshold, then event detection indicates that an event is predicted. Thus:

$${\hat{y}}_{k}^{t} = \{ \begin{matrix}1 , & if {b}_{k}^{t} > {d}_{k}^{t} and {u}_{k}^{t} < V \\ 0 , & otherwise\end{matrix}$$

where ŷₖ^{t} is the model prediction for class k in time segment t and where V is a vacuity threshold.

The use of complementary data sources (e.g., video and audio) can improve the accuracy of event detection 108, as the respective models may be jointly trained. The environment of a complex system 102 may include varying lighting conditions, visual obstructions, and ambient noise levels. Using multiple types of data in tandem makes it easier to identify deviations from normal operations that might be missed if only one form of data were used. Event detection may be used to identify hazards before they happen or cause injury of damage. Other types of events are also contemplated, such as monitoring human safety conditions, responding to emergencies, detect intruders, detect fire and water hazards, road conditions, and traffic violations.

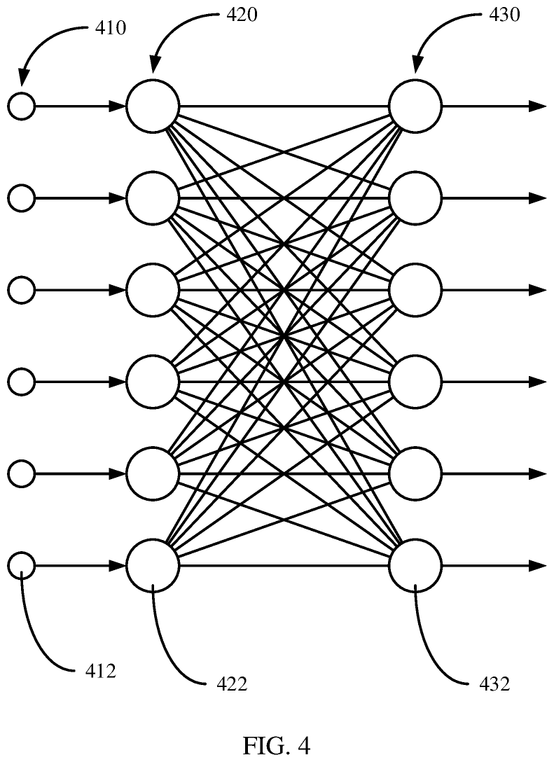

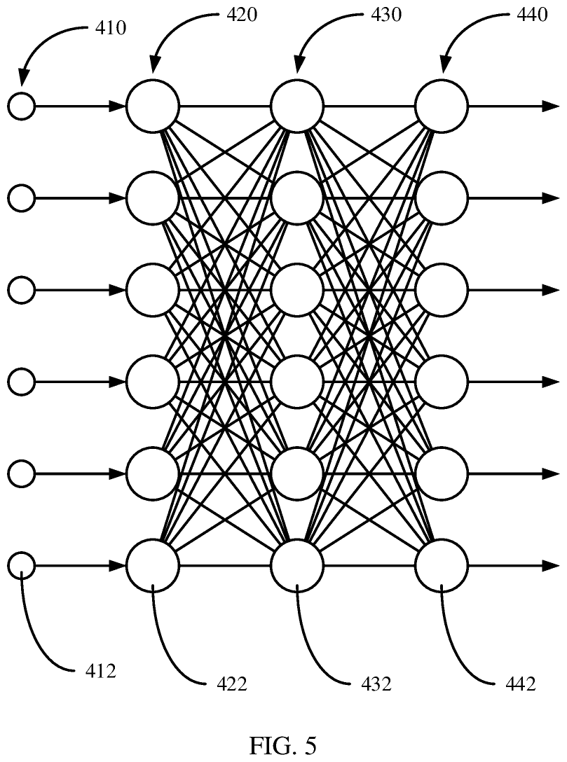

Referring now to FIGS. 4 and 5, exemplary neural network architectures are shown, which may be used to implement parts of the present models. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be outputted.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 420 of source nodes 422, and a single computation layer 430 having one or more computation nodes 432 that also act as output nodes, where there is a single computation node 432 for each possible category into which the input example could be classified. An input layer 420 can have a number of source nodes 422 equal to the number of data values 412 in the input data 410. The data values 412 in the input data 410 can be represented as a column vector. Each computation node 432 in the computation layer 430 generates a linear combination of weighted values from the input data 410 fed into input nodes 420, and applies a non-linear activation function that is differentiable to the sum. The exemplary simple neural network can perform classification on linearly separable examples (e.g., patterns).

A deep neural network, such as a multilayer perceptron, can have an input layer 420 of source nodes 422, one or more computation layer(s) 430 having one or more computation nodes 432, and an output layer 440, where there is a single output node 442 for each possible category into which the input example could be classified. An input layer 420 can have a number of source nodes 422 equal to the number of data values 412 in the input data 410. The computation nodes 432 in the computation layer(s) 430 can also be referred to as hidden layers, because they are between the source nodes 422 and output node(s) 442 and are not directly observed. Each node 432, 442 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the inputted data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 432 in the one or more computation (hidden) layer(s) 430 perform a nonlinear transformation on the input data 412 that generates a feature space. The classes or categories may be more easily separated in the feature space than in the original data space.

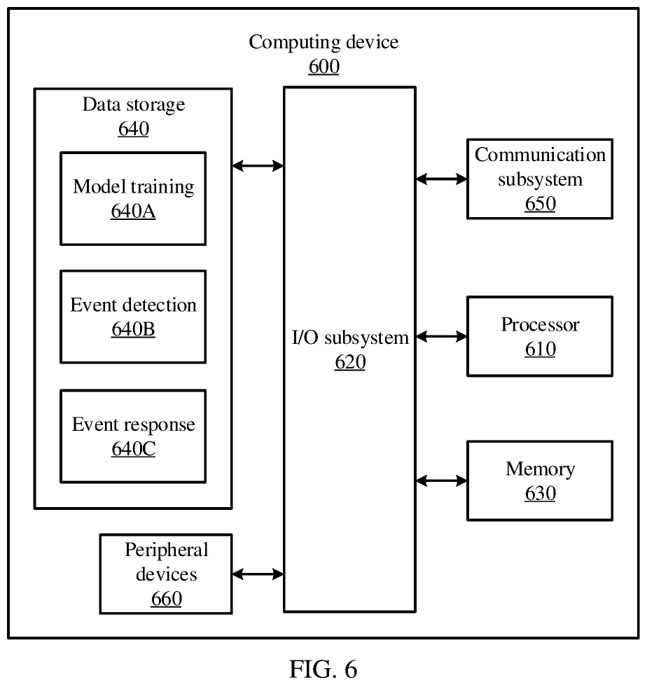

Referring now to FIG. 6, an exemplary computing device 600 is shown, in accordance with an embodiment of the present invention. The computing device 600 is configured to perform classifier enhancement.

The computing device 600 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 600 may be embodied as one or more compute sleds, memory sleds, or other racks, sleds, computing chassis, or other components of a physically disaggregated computing device.

As shown in FIG. 6, the computing device 600 illustratively includes the processor 610, an input/output subsystem 620, a memory 630, a data storage device 640, and a communication subsystem 650, and/or other components and devices commonly found in a server or similar computing device. The computing device 600 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 630, or portions thereof, may be incorporated in the processor 610 in some embodiments.

The processor 610 may be embodied as any type of processor capable of performing the functions described herein. The processor 610 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 630 may be embodied as any type of volatile or non-volatile memory or data storage capable of performing the functions described herein. In operation, the memory 630 may store various data and software used during operation of the computing device 600, such as operating systems, applications, programs, libraries, and drivers. The memory 630 is communicatively coupled to the processor 610 via the I/O subsystem 620, which may be embodied as circuitry and/or components to facilitate input/output operations with the processor 610, the memory 630, and other components of the computing device 600. For example, the I/O subsystem 620 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 620 may form a portion of a system-on-a-chip (SOC) and be incorporated, along with the processor 610, the memory 630, and other components of the computing device 600, on a single integrated circuit chip.

The data storage device 640 may be embodied as any type of device or devices configured for short-term or long-term storage of data such as, for example, memory devices and circuits, memory cards, hard disk drives, solid state drives, or other data storage devices. The data storage device 640 can store program code 640A for performing training the joint neural network model, 640B for event detection, and/or 640C for responding to detected events. Any or all of these program code blocks may be included in a given computing system. The communication subsystem 650 of the computing device 600 may be embodied as any network interface controller or other communication circuit, device, or collection thereof, capable of enabling communications between the computing device 600 and other remote devices over a network. The communication subsystem 650 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 600 may also include one or more peripheral devices 660. The peripheral devices 660 may include any number of additional input/output devices, interface devices, and/or other peripheral devices. For example, in some embodiments, the peripheral devices 660 may include a display, touch screen, graphics circuitry, keyboard, mouse, speaker system, microphone, network interface, and/or other input/output devices, interface devices, and/or peripheral devices.

Of course, the computing device 600 may also include other elements (not shown), as readily contemplated by one of skill in the art, as well as omit certain elements. For example, various other sensors, input devices, and/or output devices can be included in computing device 600, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 600 are readily contemplated by one of ordinary skill in the art given the teachings of the present invention provided herein.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for event detection, comprising:
training a joint neural network model with respective neural networks for audio data and video data relating to a same scene, wherein the joint neural network model is configured to output a belief value, a disbelief value, and an uncertainty value; and
determining that an event has occurred based on the belief value, the disbelief value, and the uncertainty value.

2. The method of claim 1, wherein the joint neural network model includes a first network architecture that includes a transformer for video data and a second network architecture that includes a convolutional neural network (CNN) and a recurrent neural network (RNN) for audio data.

3. The method of claim 1, further comprising collecting operational data of a system that includes audio and video data streams from the same scene.

4. The method of claim 3, wherein detecting that the event has occurred includes inputting the audio and video data streams to the respective neural networks of the joint neural network model.

5. The method of claim 4, wherein the audio and video data streams are collected from a same location at a same time.

6. The method of claim 1, wherein training the joint neural network model includes minimizing a loss function that includes respective cross-entropy losses for the different data types.

7. The method of claim 1, wherein determining that the event includes determining that the belief value is greater than the disbelief value and that the uncertainty value is below a threshold value.

8. The method of claim 1, wherein the belief value, the disbelief value, and the uncertainty value sum to 1.

9. The method of claim 1, further comprising collecting new audio and video data from a new scene, wherein determining that the event has occurred includes inputting the new audio and video data to the trained joint neural network model.

10. The method of claim 1, further comprising performing an action responsive to the event, selected from the group consisting of changing a security setting for an application or hardware component, changing an operational parameter of an application or hardware component, halting an application, restarting an application, halting a hardware component, rebooting a hardware component, changing an environmental condition, and changing a network interface's status or settings.

11. A system for event detection, comprising:
a hardware processor; and
a memory that stores a computer program which, when executed by the hardware processor, causes the hardware processor to:
train a joint neural network model with respective neural networks for audio data and video data relating to a same scene, wherein the joint neural network model is configured to output a belief value, a disbelief value, and an uncertainty value; and
determine that an event has occurred based on the belief value, the disbelief value, and the uncertainty value.

12. The system of claim 11, wherein the joint neural network model includes a first network architecture that includes a transformer for video data and a second network architecture that includes a convolutional neural network (CNN) and a recurrent neural network (RNN) for audio data.

13. The system of claim 11, wherein the computer program further causes the hardware processor to collect operational data of a system that includes audio and video data streams from a same scene.

14. The system of claim 13, wherein the computer program further causes the hardware processor to input the audio and video data streams to the respective neural networks of the joint neural network model.

15. The system of claim 14, wherein the audio and video data streams are collected from the same location at a same time.

16. The system of claim 11, wherein the computer program further causes the hardware processor to minimize a loss function that includes respective cross-entropy losses for the different data types.

17. The system of claim 11, wherein the computer program further causes the hardware processor to determine that the belief value is greater than the disbelief value and that the uncertainty value is below a threshold value.

18. The system of claim 11, wherein the belief value, the disbelief value, and the uncertainty value sum to 1.

19. The system of claim 11, wherein the computer program further causes the hardware processor to collect new audio and video data from a new scene, wherein the determination that the event has occurred includes processing the new audio and video data with the trained joint neural network model.

20. The system of claim 11, wherein the computer program further causes the hardware processor to perform an action responsive to the event, selected from the group consisting of changing a security setting for an application or hardware component, changing an operational parameter of an application or hardware component, halting an application, restarting an application, halting a hardware component, rebooting a hardware component, changing an environmental condition, and changing a network interface's status or settings.
